(19) United States
(12) Patent Application Publication
(10) Pub. No.: US 2026/0211986 A1
(43) Pub. Date: Jul. 23, 2026

(54) SECURE IMAGE PROCESSING SYSTEM FOR REAL-TIME IDENTITY VERIFICATION

(71) Applicant: BANK OF AMERICA CORPORATION, Charlotte, NC (US)

(72) Inventors: Andrea M. Weisberger, Jacksonville, FL (US); Amer Ali, Jersey City, NJ (US); Saleem Gaziani, Plano, TX (US); Aaron Gee, Palm Coast, FL (US); Aisha Jenkins, Atlanta, GA (US); John Lozes, Wilmington, DE (US); Tonya Kyra Miller, Charlotte, NC (US); Manonmani Palanichamy, Fort Mill, SC (US); Aravind Singtalur, McKinney, TX (US); Asha Thekkumpurath, Frisco, TX (US)

(73) Assignee: BANK OF AMERICA CORPORATION, Charlotte, NC (US)

(21) Appl. No.: 19/032,959

(22) Filed: Jan. 21, 2025

(51) Int. Cl. G06F 21/31; G06F 21/62

(52) U.S. Cl. CPC G06F 21/31; G06F 21/629

(57) ABSTRACT

Embodiments of the invention are directed to systems, methods, and computer program products for identity verification. In some embodiments, the method includes receiving, from a first user device, an identity verification request, the identity verification request comprising information associated with a second user device; based on the identity verification request, generating a link, wherein the link is configured to grant the second user device access to a remote application; receiving, via the remote application, a first image; extracting a first metadata dataset associated with the first image; determining whether the second user is associated with a known entity; based on determining whether the second user is associated with a known entity, launching an identity verification protocol; and based on an output of the identity verification protocol, transmitting a notification to the first user device.

### FIELD OF THE INVENTION

The present invention embraces a secure image processing system for real-time identity verification.

### BACKGROUND

As audio deepfake technology becomes increasingly sophisticated, there is an increased need for a system that allows for secure, real-time identity verification during a live phone call.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention relate to systems, methods, and computer program products for identity verification, the invention including: receiving, from a first user device, an identity verification request, the identity verification request including information associated with a second user device; based on the identity verification request, generating a link, where the link is configured to grant the second user device access to a remote application; receiving, via the remote application, a first image; extracting a first metadata dataset associated with the first image; determining whether the second user is associated with a known entity; based on determining whether the second user is associated with a known entity, launching an identity verification protocol; and based on an output of the identity verification protocol, transmitting a notification to the first user device.

In some embodiments, the link is generated based on a unique value of the identity verification request.

In some embodiments, the unique value of the identity verification request includes a cryptographic hash value.

In some embodiments, the first image is obtained via a camera of the second user device and is uploaded to the remote application via the second user device.

In some embodiments, the output of the identity verification protocol includes an identity verification score.

In some embodiments, the invention further includes determining that the second user is associated with the known entity; querying a remote database associated with the known entity; and comparing a result of the query to the metadata dataset associated with the first image.

In some embodiments, the invention further includes determining that the second user is not associated with the known entity; receiving, via the remote application, a second image; extracting, using an optical character recognition (OCR) module, a second metadata dataset; and comparing the second metadata dataset to the first metadata dataset associated with the first image.

In some embodiments, the invention further includes, based on the output of the identity verification protocol, accessing a directory manager of the first user device; and creating a first entry in the directory manager, the first entry comprising information associated with the identity verification request, where the first entry causes the first user device to prevent an incoming communication from the second user device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates technical components of a system for identity verification, in accordance with one embodiment of the present disclosure;

FIG. 2 is a block diagram illustrating the system for identity verification, in accordance with one embodiment of the present disclosure; and

FIG. 3 illustrates a process flow for identity verification, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

As used herein, an “entity” may be any institution employing information technology resources and particularly technology infrastructure configured for managing electronic workflows. Typically, these workflows can be related to the people who work for the organization, its products or services, the customers or any other aspect of the operations of the organization. As such, the entity may be any institution, group, association, financial institution, establishment, company, union, authority or the like, employing information technology resources for managing electronic workflows.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, “machine learning algorithms” may refer to programs (math and logic) that are configured to self-adjust and perform better as they are exposed to more data. To this extent, machine learning algorithms are capable of adjusting their own parameters, given feedback on previous performance in making a prediction about a dataset. Machine learning algorithms contemplated, described, and/or used herein include supervised learning (e.g., using logistic regression, using back propagation neural networks, using random forests, decision trees, and the like), unsupervised learning (e.g., using an Apriori algorithm, using K-means clustering), semi-supervised learning, reinforcement learning (e.g., using a Q-learning algorithm, using temporal difference learning), and/or any other suitable machine learning model types. Each of these types of machine learning algorithms can implement any of one or more of a regression algorithm (e.g., ordinary least squares, logistic regression, stepwise regression, multivariate adaptive regression splines, locally estimated scatterplot smoothing, and the like), an instance-based method (e.g., k-nearest neighbor, learning vector quantization, self-organizing map, and the like), a regularization method (e.g., ridge regression, least absolute shrinkage and selection operator, elastic net, and the like), a decision tree learning method (e.g., classification and regression tree, C4.5, chi-squared automatic interaction detection, decision stump, random forest, multivariate adaptive regression splines, gradient boosting machines, and the like), a Bayesian method (e.g., naïve Bayes, averaged one-dependence estimators, Bayesian belief network, and the like), a kernel method (e.g., a support vector machine, a radial basis function, a linear analysis, and the like), a clustering method (e.g., k-means clustering, expectation maximization, and the like), an associated rule learning algorithm, an artificial neural network model (e.g., a Perceptron method, a back-propagation method, a Hopfield network method, a self-organizing map method, a learning vector quantization method, and the like), a deep learning algorithm (e.g., a deep belief network method, a convolution network method, a stacked auto-encoder method, and the like), a dimensionality reduction method (e.g., principal component analysis, partial least squares regression, multidimensional scaling, projection pursuit, and the like), an ensemble method (e.g., boosting, bootstrapped aggregation, stacked generalization, gradient boosting machine method, random forest method, and the like), and/or any suitable form of machine learning algorithm.

As used herein, “machine learning model” may refer to a mathematical model generated by machine learning algorithms based on sample data, known as training data, to make predictions or decisions without being explicitly programmed to do so. The machine learning model represents what was learned by the machine learning algorithm and represents the rules, numbers, and any other algorithm-specific data structures required to for classification.

The present invention provides a system and method for real-time voice verification to prevent audio deepfake security breaches. For example, based on a phone call recipient activating a verification request, the system may send a message or otherwise transmit a link to the phone number of a caller, which may grant the caller access to a secure verification portal. The caller may then upload a time-stamped photo to the verification portal, which uses image recognition technology to verify that the time-stamped photo matches a second image, such as an image of a driver's license. In some embodiments of the invention, the caller may be associated with an organization, and the system may compare the time-stamped photo to an image stored in a database managed by the organization. Once the caller's identity is verified, the system then transmits a verification notification to the recipient of the phone call. Furthermore, in some embodiments, the system may determine that the caller's identity is not verified. This may occur when a verification score calculated by the system fails to meet a certain predetermined threshold value. Based on the caller's identity not being verified, the system may be configured to take a variety of remedial steps, including blocking the caller from communicating with the recipient's device, executing an additional verification protocol, disabling system access for one or more particular users, and/or the like.

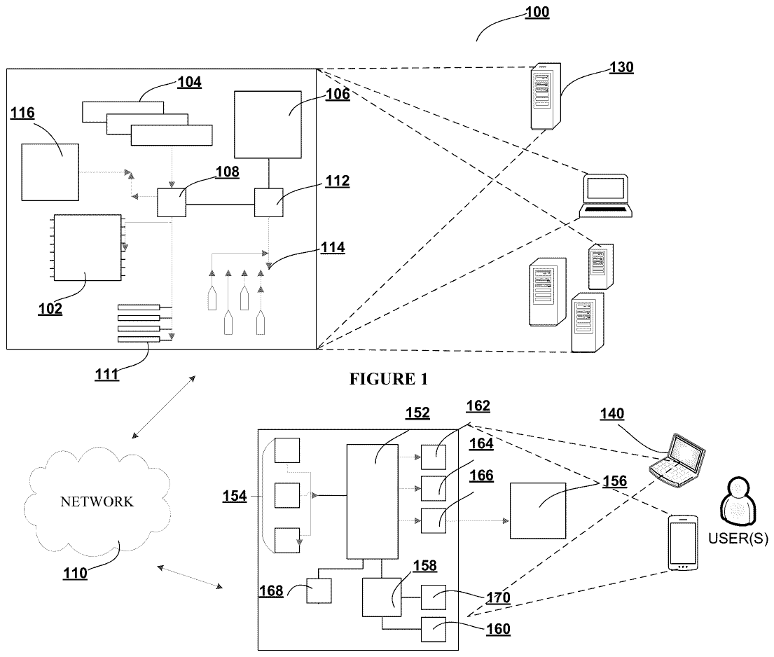

FIG. 1 presents an exemplary block diagram of a system environment 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is one or more user(s) of the user input system 140. The user input system 140 is intended to represent various forms of mobile devices, such as laptops, personal digital assistants, augmented reality (AR) devices, virtual reality (VR) devices, extended reality (XR) devices, and/or the like, and non-mobile devices such as desktops, video recorders, audio/video player, radio, workstations, and/or the like. The user may be a person who uses the user input system 140 to execute one or more processes described herein using one or more applications stored thereon. The one or more applications may be configured to communicate with the system 130, execute a process or method, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, electronic kiosk devices, blade servers, mainframes, or any combination of the aforementioned. The user input system 140 is intended to represent various forms of personal devices, such as laptops, desktops, mobile devices, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by an entity. The system 130 may be located at a facility associated with the entity or remotely from the facility associated with the entity.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140, or may also store applications or other information therein. In some embodiments, expansion memory may include instructions to carry out or supplement the processes described above, and may include secure information also. For example, expansion memory may be provided as a security module for user input system 140, and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flow discussed in greater detail with respect to FIG. 4. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation-and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

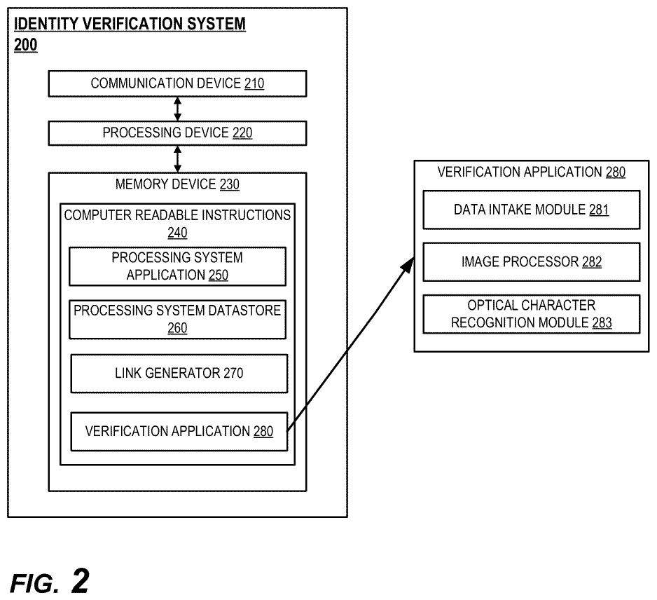

FIG. 2 illustrates a block diagram of an identity verification system 200 associated with the system environment 100, in accordance with embodiments of the present invention. As illustrated in FIG. 2, the identity verification system 200 may include a communication device 210, a processing device 220, and a memory device 230 having a processing system application, a processing system datastore 260, a link generator 270, and a verification application 280 stored therein. As shown, the processing device 220 is operatively connected to and is configured to control and cause the communication device 210 and the memory device 230 to perform one or more functions. In some embodiments, the link generator 270, the verification application 280 and/or the processing system application 250 comprise computer readable instructions 240 that when executed by the processing device 220 cause the processing device 220 to perform one or more functions and/or transmit control instructions to other systems, applications, and/or devices in the system environment 100. It will be understood that the link generator 270, the verification application 280, and/or the processing system application 250 may be executable to initiate, perform, complete, and/or facilitate one or more portions of any embodiments described and/or contemplated herein.

The link generator 270 may be configured to generate, based on received data, a unique link granting a user and/or user device access to the features and functions of the verification application 280. For example, in some embodiments, the link generator 270 may receive a unique identification value associated with an identity verification request. The link generator 270 may then generate a custom link associated with the unique identification value and may store the custom link in a data table in the processing system datastore 260. In some embodiments, for enhanced security, the link generator 270 may generate the custom link based on a cryptographic hash value generated from data associated with the identity verification request. By doing so, the system may reduce the probability of an unauthorized entity gaining access to the verification application 280 by reverse-engineering a unique link.

The verification application 280 may further comprise a data intake module 281, an image processing module or image processor 282, and an optical character recognition (OCR) module 283. In some embodiments, the verification application 280 may comprise a portal, webpage, or standalone application or module configured to be launched on a user device. The data intake module 271 may be configured to obtain, from a user device, structured and/or unstructured data inputs such as text, images, video files, audio files, authentication credentials, and/or the like. In some embodiments, the data intake module 271 may be configured to obtain said data inputs by accessing a hardware component of a user device, such as a camera or microphone. Additionally or alternatively, the data intake module 271 may be configured to query a datastore of the user device and/or other remote database(s).

The image processor 282 and the OCR module 283 may be configured to extract, from data received by the data intake module 281, one or more sets of metadata. For example, in some embodiments, the image processor 282 may be configured to extract, from an image, metadata such as geographic data, a timestamp, alteration data, authorship data, and/or the like. In some embodiments, the OCR module 283 may be configured to extract text data, modification data, and/or other metadata from an image file. The OCR module 283 may be further configured to perform data processing on the extracted data, such as natural language processing and/or the like.

The communication device 210 may generally include a modem, server, transceiver, and/or other devices for communicating with other devices on the network 101. The communication device 210 may be a communication interface having one or more communication devices configured to communicate with one or more other devices on the network 101.

Additionally, referring to the identity verification system 200 illustrated in FIG. 2, the processing device 220 may generally refer to a device or combination of devices having circuitry used for implementing the communication and/or logic functions of the identity verification system 200. For example, the processing device 220 may include a control unit, a digital signal processor device, a microprocessor device, and various analog-to-digital converters, digital-to-analog converters, and other support circuits and/or combinations of the foregoing. Control and signal processing functions of the data obfuscation system 200 may be allocated between these processing devices according to their respective capabilities. The processing device 220 may further include functionality to operate one or more software programs based on computer-executable program code 240 thereof, which may be stored in a memory device 230, such as the processing system application 250 and the verification application 280. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 220 may be configured to use the network communication interface of the communication device 210 to transmit and/or receive data and/or commands to and/or from the other devices/systems connected to the network 101.

The memory device 230 within the identity verification system 200 may generally refer to a device or combination of devices that store one or more forms of computer-readable media for storing data and/or computer-executable program code/instructions. For example, the memory device 230 may include any computer memory that provides an actual or virtual space to temporarily or permanently store data and/or commands provided to the processing device 220 when it carries out its functions described herein. As used herein, memory may include any computer readable medium configured to store data, code, or other information. The memory device 350 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the identity verification system 200 performing one or more steps described herein in conjunction with other devices and systems, either automatically based on executing computer readable instructions of the memory device 230, or in response to receiving control instructions from another device in the system environment 100. In some instances, the system refers to the devices and systems on the system environment 100 of FIG. 1. The features and functions of various embodiments of the invention are be described below in further detail. It is understood that the servers, systems, and devices described herein illustrate one embodiment of the invention. It is further understood that one or more of the servers, systems, and devices can be combined in other embodiments and still function in the same or similar way as the embodiments described herein.

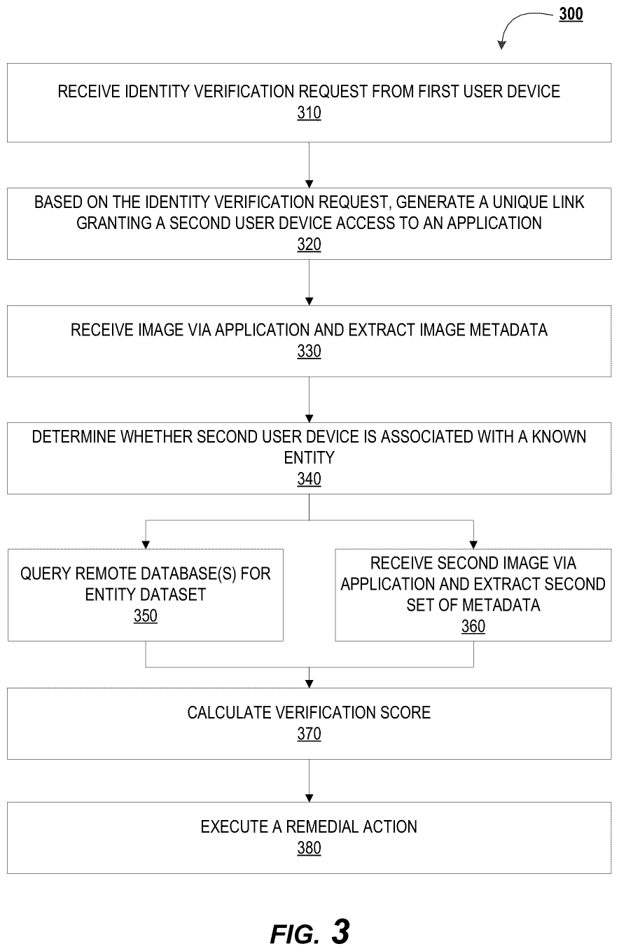

FIG. 3 is a high-level process flow diagram illustrating a process 300 using the identity verification system, in accordance with one embodiment of the present disclosure. The process begins at block 310, where the system is configured to receive, from a first user device, an identity verification request. In some embodiments, the identity verification request may comprise information associated with a second user device. For example, the first user device may receive a call from the second user device. During the call, the user of the first user device may wish to verify the caller's identity and may transmit an identity verification request to the system via an application, instant message, webpage, SMS message, and/or the like. In some embodiments, the user may manually input information associated with the second user device, such as a phone number, name, associated entity, and/or the like. Additionally or alternatively, the system may be configured to access the call log or other local datastore of the user device to extract the information associated with the second user device, without requiring an additional user input. Thus, the user is able to launch the identity verification process with minimal interruption to the ongoing phone call.

The process flow may then continue to block 320 where the system is configured to, based on the identity verification request, generate a link (such as a URL or the like) and transmit said link to the second user device. In some embodiments, the link is configured to grant the second user device access to a remote application. As described in greater detail with respect to FIG. 2, the link may be generated based on a unique value of the identity verification request, and/or may be generated based on a cryptographic hash value associated with the identity verification request. In some embodiments, the link may be set to expire after a predetermined period of time. In some embodiments, the system may be further configured to use the link generator 270 to generate a link allowing the first user device to also access the remote application and monitor the identity verification process.

The process flow may then continue to block 330 where the system is configured to receive, via the data intake module 281 of the remote application, a first image. In some embodiments, the first image is obtained via a camera of the second user device and is uploaded to the remote application via the second user device. In some embodiments, the image may be an image of the second user of the second user device. The system may then extract a first metadata dataset associated with the first image, including but not limited to a timestamp, geolocation data, alteration data, and/or the like.

The process flow may then continue to block 340 where the system may determine whether the second user is associated with a known entity. In some embodiments, for example, the identity verification request may indicate whether the caller is claiming to be a member of a particular, known entity. Additionally or alternatively, the system may receive, through the remote application, a user input from the second user device indicating a specific entity. Based on determining whether the second user is associated with a known entity, the system may then launch an identity verification protocol according to either block 350 or 360 of the process flow.

In some embodiments, the system may determine that the second user is associated with a known entity, such as an organization, and the process flow may continue to block 350. The system may be configured query a remote database associated with the known entity, such as a personnel database for information associated with the second user device such as a name, image, phone number, location, and/or the like. The system may then compare a result of the query to the metadata dataset associated with the first image. For example, the system may compare an image from the personnel database to the image uploaded to the remote application in order to determine a degree of similarity between the two images.

Additionally or alternatively, the system may determine that the second user is not associated with the known entity and may process to block 360, where the system may receive, via the remote application, a second image. In some embodiments, the second image may comprise an image of a document, photo identification, and/or the like. The system may then be configured to extract, using the optical character recognition (OCR) module 283, a second metadata dataset based on the second image. The system may then compare the second metadata dataset to the first metadata dataset to determine a degree of similarity between the two.

The process flow may then continue to block 370, where the system is configured to calculate a verification score based on the results of the similarity analysis at block 350 and/or block 360. For example, the system may determine that the first image uploaded to the remote application has a high degree of similarity to an image in the personnel database, which may increase the verification score. The verification score may also be increased or decreased according to other relevant factors, such as a timestamp of the first image, a location of the first image or the second user device, and/or the like.

The process flow may then continue to block 380, where the system is configured to execute a remedial action. In some embodiments, based on an output of the identity verification protocol (such as the verification score), the system may transmit a notification to the first user device. If the verification score does not exceed a predetermined threshold value (i.e., if the identify verification process has failed to verify the identity of the second user device), the system may be further configured to access a directory manager of the first user device. The system may then create an entry in the directory manager, where the entry causes the first user device to prevent an incoming communication from the second user device. For example, the system may add the phone number of the second user device to a blocklist of the directory manager such that future incoming calls from the second user device are automatically blocked by the first user device.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for identity verification, the system comprising:
at least one non-transitory storage device; and
at least one processing device coupled to the at least one non-transitory storage device, wherein the at least one processing device is configured to:
receive, from a first user device, an identity verification request, the identity verification request comprising information associated with a second user device;
based on the identity verification request, generate a link, wherein the link is configured to grant the second user device access to a remote application;
receive, via the remote application, a first image;
extract a first metadata dataset associated with the first image;
determine whether the second user is associated with a known entity;
based on determining whether the second user is associated with a known entity, launch an identity verification protocol; and
based on an output of the identity verification protocol, transmit a notification to the first user device.

2. The system of claim 1, wherein the link is generated based on a unique value of the identity verification request.

3. The system of claim 2, wherein the unique value of the identity verification request comprises a cryptographic hash value.

4. The system of claim 1, wherein the first image is obtained via a camera of the second user device and is uploaded to the remote application via the second user device.

5. The system of claim 1, wherein the output of the identity verification protocol comprises an identity verification score.

6. The system of claim 1, wherein the at least one processing device is further configured to:
determine that the second user is associated with the known entity;
query a remote database associated with the known entity; and
compare a result of the query to the metadata dataset associated with the first image.

7. The system of claim 1, wherein the at least one processing device is further configured to:
determine that the second user is not associated with the known entity;
receive, via the remote application, a second image;
extract, using an optical character recognition (OCR) module, a second metadata dataset; and
compare the second metadata dataset to the first metadata dataset associated with the first image.

8. The system of claim 1, wherein the at least one processing device is further configured to:
based on the output of the identity verification protocol, access a directory manager of the first user device; and
create a first entry in the directory manager, the first entry comprising information associated with the identity verification request, wherein the first entry causes the first user device to prevent an incoming communication from the second user device.

9. A computer program product for identity verification, the computer program product comprising at least one non-transitory computer-readable medium having computer-readable program code portions embodied therein, the computer-readable program code portions comprising:
an executable portion configured for receiving, from a first user device, an identity verification request, the identity verification request comprising information associated with a second user device;
an executable portion configured for, based on the identity verification request, generating a link, wherein the link is configured to grant the second user device access to a remote application;
an executable portion configured for receiving, via the remote application, a first image;
an executable portion configured for extracting a first metadata dataset associated with the first image;
an executable portion configured for determining whether the second user is associated with a known entity;
an executable portion configured for, based on determining whether the second user is associated with a known entity, launching an identity verification protocol; and
an executable portion configured for, based on an output of the identity verification protocol, transmit a notification to the first user device.

10. The computer program product of claim 9, wherein the link is generated based on a unique value of the identity verification request.

11. The computer program product of claim 10, wherein the unique value of the identity verification request comprises a cryptographic hash value.

12. The computer program product of claim 9, wherein the first image is obtained via a camera of the second user device and is uploaded to the remote application via the second user device.

13. The computer program product of claim 9, wherein the output of the identity verification protocol comprises an identity verification score.

14. The computer program product of claim 9, further comprising:
an executable portion configured for determining that the second user is associated with the known entity;
an executable portion configured for querying a remote database associated with the known entity; and
an executable portion configured for comparing a result of the query to the metadata dataset associated with the first image.

15. The computer program product of claim 9, further comprising:
an executable portion configured for determining that the second user is not associated with the known entity;
an executable portion configured for receiving, via the remote application, a second image;
an executable portion configured for extracting, using an optical character recognition (OCR) module, a second metadata dataset; and
an executable portion configured for comparing the second metadata dataset to the first metadata dataset associated with the first image.

16. The computer program product of claim 9, further comprising:
an executable portion configured for, based on the output of the identity verification protocol, accessing a directory manager of the first user device; and
an executable portion configured for creating a first entry in the directory manager, the first entry comprising information associated with the identity verification request, wherein the first entry causes the first user device to prevent an incoming communication from the second user device.

17. A computer-implemented method for identity verification, the method comprising:
providing a computing system comprising a computer processing device and a non-transitory computer readable medium, wherein the computer readable medium comprises configured computer program instruction code, such that when said instruction code is operated by said computer processing device, said computer processing device performs the following operations:
receiving, from a first user device, an identity verification request, the identity verification request comprising information associated with a second user device;
based on the identity verification request, generating a link, wherein the link is configured to grant the second user device access to a remote application;
receiving, via the remote application, a first image;
extracting a first metadata dataset associated with the first image;
determining whether the second user is associated with a known entity;
based on determining whether the second user is associated with a known entity, launching an identity verification protocol; and
based on an output of the identity verification protocol, transmitting a notification to the first user device.

18. The method of claim 17, wherein the link is generated based on a unique value of the identity verification request, the unique value comprising a cryptographic hash value.

19. The method of claim 17, further comprising:
determining that the second user is not associated with the known entity;
receiving, via the remote application, a second image;
extracting, using an optical character recognition (OCR) module, a second metadata dataset; and
comparing the second metadata dataset to the first metadata dataset associated with the first image.

20. The method of claim 17, further comprising:
based on the output of the identity verification protocol, accessing a directory manager of the first user device; and
creating a first entry in the directory manager, the first entry comprising information associated with the identity verification request, wherein the first entry causes the first user device to prevent an incoming communication from the second user device.
